(19) United States
(12) Patent Application Publication
(10) Pub. No.: US 2018/0069290 A1
(43) Pub. Date: Mar. 8, 2018

(54) GLASS ANTENNA

(71) Applicant: ASAHI GLASS COMPANY, LIMITED, Tokyo (JP)

(72) Inventors: Tsuyoshi YAMAMOTO, Tokyo (JP); Yohei KOMATSU, Tokyo (JP); Koji TABATA, Tokyo (JP)

(73) Assignee: ASAHI GLASS COMPANY, LIMITED, Tokyo (JP)

(21) Appl. No.: 15/695,923

(22) Filed: Sep. 5, 2017

(30) Foreign Application Priority Data
Sep. 6, 2016 (JP) 2016-174035

(51) Int. Cl. H01Q 1/12; H05B 3/84; H01Q 21/30; H01Q 5/40; H01Q 1/32

(52) U.S. Cl. CPC H01Q 1/1278; H05B 3/84; H01Q 1/325; H01Q 21/30; H01Q 5/40; H01Q 1/1285

(57) ABSTRACT

The glass antenna of the present invention includes a first element connected to a hot-side feeding point, a second element connected to an earth-side feeding point and a coaxial cable having an inner conductor and an outer conductor that is connected to a part of a vehicle body. The glass antenna of the present can improve receiving sensitivity.

### FIELD OF THE INVENTION

The present invention relates to a glass antenna.

### BACKGROUND OF THE INVENTION

In recent years, there has been known a glass antenna for a vehicle, whose feeding points consist of two poles on a hot side and an earth side (for example, see Patent Document 1). In such a glass antenna for a vehicle, an inner conductor of a coaxial cable is connected to the hot-side feeding point, and an outer conductor of the coaxial cable is connected to the earth-side feeding point. In addition, the outer conductor of the coaxial cable is typically earthed (midpoint-earthed) to a vehicle body in the vicinity of the earth-side feeding point. In addition, each of a first element connected to the hot-side feeding point and a second element connected to the earth-side feeding point is typically set to have a length of about ¼λ when the wavelength of a central frequency of a frequency band to be received is λ.
Patent Document 1: JP-A-2002-185230

### SUMMARY OF THE INVENTION

However, for example, when the vehicle has a hatchback door made from resin, it is sometimes difficult to midpoint-earth in the vicinity of the earth-side feeding point. In such a case, it is difficult to obtain a satisfactory receiving sensitivity (antenna gain) in the aforementioned glass antenna.

The present invention has been developed to solve the foregoing problem. An object of the invention is to provide a glass antenna capable of improving receiving sensitivity thereof.

The present invention has the following configurations.

[1] A glass antenna including: a first element that is disposed in, of a rear glass for a vehicle, a peripheral region of a defogger including a plurality of heating wires, and connected to a first feeding point, the first element capable of resonating with a frequency band to be received; a second element that is disposed in opposition to and in parallel with at least a part of the first element, and connected to a second feeding point, the second element having a length between a length obtained by multiplying ½ of a wavelength corresponding to the frequency band to be received by a wavelength shortening rate of the rear glass and a length obtained by multiplying the wavelength by the wavelength shortening rate; and a coaxial cable that includes an inner conductor connected to the first feeding point and an outer conductor connected to the second feeding point, the outer conductor being connected to a part of a body of the vehicle.

[2] The glass antenna according to [1], in which the outer conductor of the coaxial cable is connected to a part of the body of the vehicle in a position corresponding to a length of at least ¼ of the wavelength from the second feeding point.

[3] The glass antenna according to [1] or [2], in which the first element and the second element are disposed at a distance from each other so that the first element and the second element are capacitively coupled with each other in the frequency band to be received.

[4] The glass antenna according to any one of [1] to [3], in which the first element is disposed to be capacitively coupled with the defogger in the frequency band to be received; and the second element is disposed to be capacitively coupled with a third element in the frequency band to be received, the third element being connected to the defogger.

[5] The glass antenna according to any one of [1] to [4], in which the first element is disposed between the second element and the defogger.

[6] The glass antenna according to any one of [1] to [5], in which the wavelength is a wavelength corresponding to a central frequency of the frequency band to be received.

[7] The glass antenna according to any one of [1] to [6], in which the rear glass for the vehicle is attached to a backdoor made from resin, the backdoor being openably and closably attached to a rear portion of the vehicle.

According to the glass antenna of the invention, it is possible to improve receiving sensitivity.

### BRIEF DESCRIPTION OF THE DRAWINGS

FIG. 1 is a view showing an example in which a glass antenna according to a first embodiment is mounted on a vehicle.

FIG. 2 is a view showing a configuration example of the glass antenna according to the first embodiment.

FIG. 3 is a graph showing an improved value of receiving sensitivity in an example of the glass antenna according to the first embodiment.

FIG. 4 is a view showing a configuration example of a glass antenna according to a second embodiment.

FIG. 5 is a view showing a configuration example of a glass antenna according to a third embodiment.

### DETAILED DESCRIPTION OF THE INVENTION

The following definitions of terms are applied to the present specification.

A glass antenna according to each embodiment of the invention will be described below with reference to the drawings.

### First Embodiment

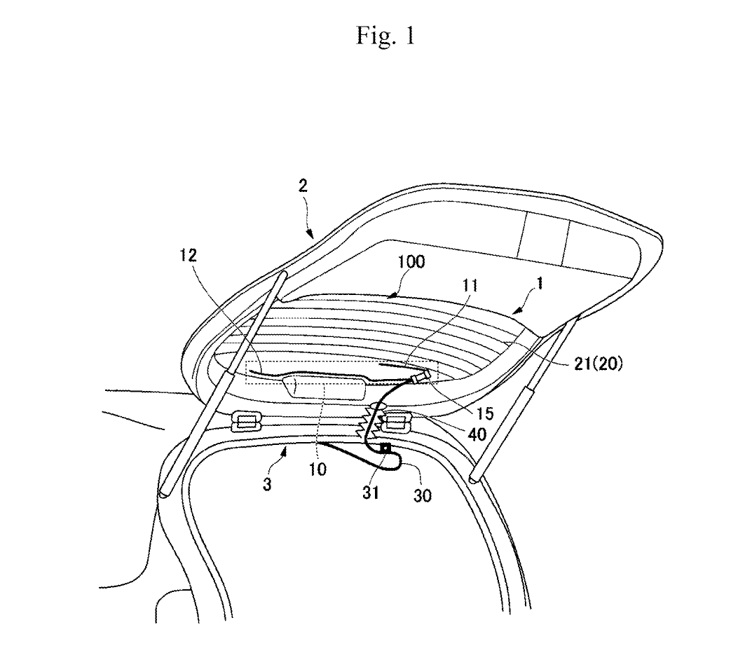

FIG. 1 is a view showing an example in which a glass antenna 1 according to a first embodiment is mounted on a vehicle.

As shown in FIG. 1, the glass antenna 1 is attached to a backdoor 2 of the vehicle (which is, for example, a hatchback type car). The backdoor 2 is, for example, made from resin, and openably and closably attached to a rear portion of the vehicle.

The glass antenna 1 has a rear glass 100 for the vehicle. A DAB antenna portion 10 and a defogger 20 including heating wires 21 are disposed in the rear glass 100. In addition, the DAB antenna portion 10 has a first element 11, a second element 12, and a DAB amplifier 15. The DAB antenna portion 10 is connected to a coaxial cable 30 through the DAB amplifier 15.

The DAB antenna portion 10 is a bipolar type antenna for receiving radio waves in a DAB frequency band. “DAB” is a standard for Digital Audio Broadcast, which is a digital radio. In addition, DAB includes two different frequency bands, that is, band III ranging from 174 MHz (megahertz) to 240 MHz, and L-band ranging from 1,452 MHz to 1,492 MHz. In this embodiment, the DAB antenna portion 10 is an antenna for receiving radio waves in the frequency band of 174 MHz to 240 MHz (band III) by way of example. In addition, in the following description, “DAB frequency band” is a frequency band to be received. For example, description will be made on the assumption that the DAB frequency band is a frequency band of 174 MHz to 240 MHz (band III).

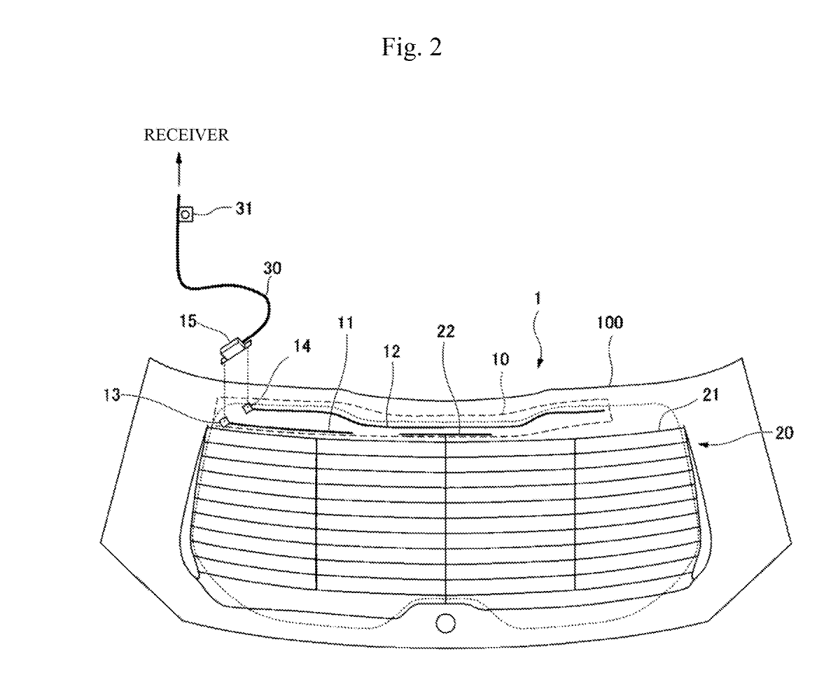

In addition, the details of the DAB antenna portion 10 will be described later with reference to FIG. 2.

The coaxial cable 30 is routed to the vehicle body 3 side through a grommet 40, and connected to a receiver such as a DAB digital radio. In addition, the coaxial cable 30 has an inner conductor, and an outer conductor covering the outside of the inner conductor through an insulator. The outer conductor of the coaxial cable 30 is connected to a part of the vehicle body 3 (the body of the vehicle) through a midpoint earth 31.

In the embodiment, the backdoor 2 is made from resin. Accordingly, the outer conductor of the coaxial cable 30 is connected to the vehicle body 3 made from metal, by a grounding portion (midpoint earth 31) located in the position where the coaxial cable 30 is routed to the vehicle body 3 side through the grommet 40. The outer conductor of the coaxial cable 30 is connected to a part of the vehicle body 3 by the midpoint earth 31 in a position corresponding to at least ¼ of a wavelength λ corresponding to the DAB frequency band (for example, a wavelength corresponding to a central frequency of the DAB frequency band). The midpoint earth 31 is, for example, provided in the vicinity of an outlet of the grommet 40 on the vehicle body 3 side.

Next, a configuration of the glass antenna 1 will be described with reference to FIG. 2.

FIG. 2 is a view showing a configuration example of the glass antenna 1 according to the embodiment. FIG. 2 is a view in which the glass antenna 1 is observed from the inside of the vehicle in a state where the rear glass 100 attached to the backdoor 2 has been removed.

As shown in FIG. 2, the glass antenna 1 includes the rear glass 100, the DAB amplifier 15, and the coaxial cable 30.

The rear glass 100 is a rear glass for the vehicle. The rear glass 100 is, for example, made of glass. The rear glass 100 is attached to the backdoor 2 (rear door), and disposed in an opening portion of the backdoor 2 shown by the dotted line, so that the rear of the vehicle can be visually recognized. In addition, the defogger 20, the DAB antenna portion 10 enclosed by the broken line, and a T-shaped element 22 are disposed in the rear glass 100.

The defogger 20 is disposed at the center of the rear glass 100. The defogger 20 includes a plurality of heating wires 21 (heating wire conductors). Using electric power supplied from the vehicle through the backdoor 2, the defogger 20 heats the plurality of heating wires 21 to eliminate dew condensation from the rear glass 100.

The T-shaped element 22 (an example of a third element) is a T-shaped conductor such as metal disposed in the rear glass 100. The T-shaped element 22 is connected to the heating wires 21 of the defogger 20. The T-shaped element 22 is, for example, connected to the centers of the heating wires 21. A lower end of a vertical part of the T-shaped element 22 does not have to be extended downward below the lowermost one of the heating wires 21 as shown in FIG. 2. The lower end thereof may be extended to a central one of the heating wires 21, or extended to the uppermost one of the heating wires 21.

The DAB antenna portion 10 is disposed in a peripheral region of the defogger 20 (for example, a blank region on the upper side of the defogger 20) of the rear glass 100. The DAB antenna portion 10 includes the first element 11, the second element 12, a hot-side feeding point 13, and an earth-side feeding point 14. The hot-side feeding point 13 and the earth-side feeding point 14 in the embodiment are disposed in a blank region (a left upper portion of an upper region) on the upper side of the defogger 20. In addition, the first element 11 and the second element 12 in the embodiment are disposed in the blank region on the upper side of the defogger 20. The first element 11 extends from a left portion toward a central portion, and the second element 12 extends from the left portion toward a right portion.

The first element 11 is a conductor such as metal disposed in the rear glass 100. The first element 11 is disposed in, of the rear glass 100, the peripheral region of the defogger 20, and connected to the hot-side feeding point 13. The first element 11 is, for example, disposed in the blank region on the upper side of the defogger 20 so as to extend along the heating wires 21 of the defogger 20. In addition, the first element 11 is disposed at a predetermined distance (for example, a distance of 10 mm) from the defogger 20 so as to be capacitively coupled with the defogger 20 in the DAB frequency band (frequency band to be received). In addition, the first element 11 has a length (for example, a length of ¼ of the aforementioned wavelength λ) capable of resonating with the DAB frequency band (frequency band to be received).

The hot-side feeding point 13 (an example of a first feeding point) is formed out of a conductor such as metal, and connected to the first element 11. The hot-side feeding point 13 is a terminal for feeding power to the first element 11. In addition, the hot-side feeding point 13 is, for example, connected to the DAB amplifier 15 by soldering, and connected to the inner conductor of the coaxial cable 30 through the DAB amplifier 15.

The second element 12 is a conductor such as metal disposed in the rear glass 100. The second element 12 is disposed in the peripheral region of the defogger 20 so as to extend in opposition to and in parallel with at least a part of the first element 11, and connected to the earth-side feeding point 14. The second element 12 is, for example, disposed in, of the rear glass 100, the blank region on the upper side of the defogger 20 and outside the first element 11 (on an edge side of the rear glass). In addition, the second element 12 is disposed to extend along the opening portion (flange) of the backdoor 2. In addition, the second element 12 is disposed at a predetermined distance (for example, a distance of 10 mm) from the T-shaped element 22 connected to the defogger 20 so as to be capacitively coupled with the T-shaped element 22 in the DAB frequency band.

In addition, the second element 12 has a length between ½×0.64 of the wavelength λ and 0.64 of the wavelength λ (½λ×0.64 to λ×0.64) when a wavelength shortening rate k of the rear glass 100 is 0.64. That is, the second element 12 has a length between a length obtained by multiplying ½ of the wavelength λ by the wavelength shortening rate (k=0.64) of the rear glass 100 and a length obtained by multiplying the wavelength λ by the wavelength shortening rate (k=0.64). The wavelength shortening rate (k) is also referred to as glass shortening rate. The wavelength shortening rate (k) is a rate with which the wavelength of a radio wave is shortened when the radio wave passes through the glass. The second element 12 has more preferably a length between ¾×k×(1−P) of the wavelength λ and ¾×k×(1+P) of the wavelength λ (for example, when P=0.3, a length between ¾λ×0.64×0.7 and ¾λ×0.64×1.3).

In addition, the first element 11 and the second element 12 are disposed substantially in parallel with each other and at a distance from each other so that the first element 11 and the second element 12 are capacitively coupled with each other in the DAB frequency band. In addition, the first element 11 and the second element 12 are disposed with the second element 12 on the peripheral side (flange side) and the first element 11 on the defogger 20 side.

The earth-side feeding point 14 (an example of a second feeding point) is formed out of a conductor such as metal, and connected to the second element 12. The earth-side feeding point 14 is an earth-side (ground-side) terminal for feeding power to the second element 12. In addition, the earth-side feeding point 14 is, for example, connected to the DAB amplifier 15 by soldering, and connected to the outer conductor of the coaxial cable 30 through the DAB amplifier 15.

The DAB amplifier 15 amplifies a signal of the DAB frequency band received by the first element 11 and the second element 12, and outputs the amplified signal to a receiver through the coaxial cable 30.

The inner conductor of the coaxial cable 30 is connected to the hot-side feeding point 13 through an amplification circuit of the DAB amplifier 15. On the other hand, the outer conductor of the coaxial cable 30 is connected to the earth-side feeding point 14 through an earth circuit (ground wire) of the DAB amplifier 15. In addition, the outer conductor of the coaxial cable 30 is connected (earthed) to the vehicle body 3 through the midpoint earth 31. The length of the coaxial cable 30 between the earth-side feeding point 14 and the midpoint earth 31 is, for example, at least ¼ of the wavelength λ.

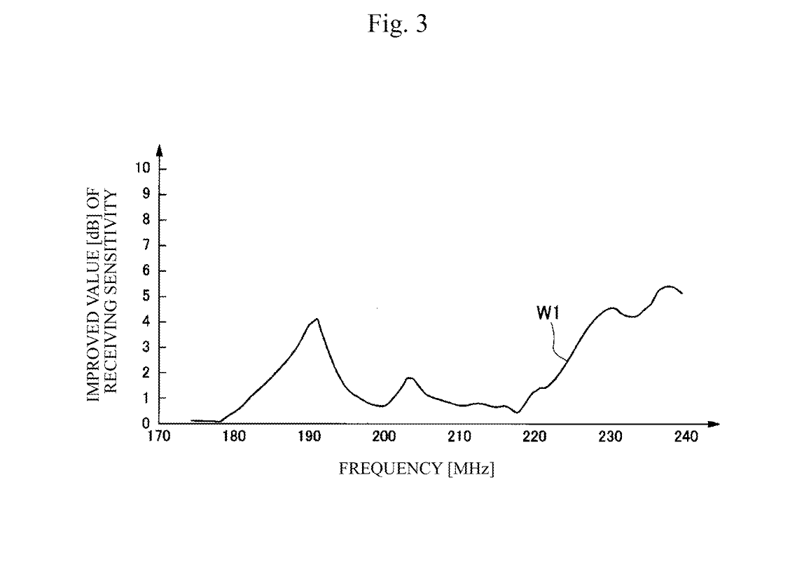

Next, the receiving sensitivity (antenna gain) of the glass antenna 1 according to the embodiment will be described with reference to FIG. 3.

FIG. 3 is a graph showing an improved value of receiving sensitivity in an example of the glass antenna 1 according to the embodiment.

The graph shown in FIG. 3 draws a difference between the antenna gain of a glass antenna according to the background art and the antenna gain of the glass antenna 1 according to the embodiment in the DAB frequency band (e.g. 174 MHz to 240 MHz) as an improved value of receiving sensitivity. Specific configurations of the glass antenna according to the background art and the glass antenna 1 according to the embodiment will be described below.

In the glass antenna according to the background art, the length of each of a first element and a second element is about 1/λ×wavelength shortening rate (k=0.64), which is, for example, 250 mm (millimeters). In addition, the length of a coaxial cable between an earth-side feeding point (or a DAB amplifier) and a midpoint earth is, for example, 800 mm.

On the other hand, in an example of the glass antenna 1 according to the embodiment, the length of the first element 11 is, for example, 250 mm, and the length of the second element 12 is, for example, 670 mm. In addition, the length of the coaxial cable 30 between the earth-side feeding point 14 (or the DAB amplifier 15) and the midpoint earth 31 is, for example, 800 mm. In addition, the distance between the first element 11 and the heating wires 21 of the defogger 20 is a distance capable of capacitively coupling in the DAB frequency band, for example, 10 mm. In addition, the distance between the second element 12 and the T-shaped element 22 is, for example, 10 mm.

In addition, the ordinate of the graph shown in FIG. 3 designates an improved value [dB (decibel)] of receiving sensitivity, and the abscissa thereof designates a frequency [MHz]. In addition, a waveform W1 designates an improved value of receiving sensitivity in which the antenna gain of the glass antenna according to the background art is subtracted from the antenna gain of the glass antenna 1 according to the embodiment when a vertical polarization wave is received in the aforementioned configuration examples.

As shown by the wavelength W1 in FIG. 3, the glass antenna 1 according to the embodiment can improve the receiving sensitivity (antenna gain) by about 2 dB on average in the DAB frequency band (e.g. 174 MHz to 240 MHz) as compared with the glass antenna according to the background art.

As described above, the glass antenna 1 according to the embodiment includes the first element 11, the second element 12, and the coaxial cable 30. The first element 11 is disposed in, of the rear glass 100 (rear glass) for the vehicle, the peripheral region of the defogger 20 including the heating wires 21, and connected to the hot-side feeding point 13 (first feeding point). In addition, the first element 11 can resonate with the DAB frequency band (frequency band to be received). The second element 12 is disposed in opposition to and in parallel with at least a part of the first element 11, and connected to the earth-side feeding point 14 (second feeding point). In addition, the second element 12 has a length between a length obtained by multiplying ½ of the wavelength λ corresponding to the DAB frequency band (frequency band to be received) by the wavelength shortening rate (k=0.64) of the rear glass 100 and a length obtained by multiplying the wavelength λ by the wavelength shortening rate (k=0.64). The coaxial cable 30 includes an inner conductor connected to the hot-side feeding point 13, and an outer conductor connected to the earth-side feeding point 14. The outer conductor is connected to a part of the vehicle body 3 (the body of the vehicle).

Thus, in the glass antenna 1 according to the embodiment, the length of the second element 12 connected to the earth-side feeding point 14 is set between the length obtained by multiplying ½ of the wavelength λ by the wavelength shortening rate of the rear glass 100 and the length obtained by multiplying the wavelength λ by the wavelength shortening rate, so that the impedance of the glass antenna 1 can be lowered. As a result, the glass antenna 1 according to the embodiment can improve the receiving sensitivity (antenna gain). In addition, the glass antenna 1 according to the embodiment can reduce (be hard to receive) influence of noise, as compared with a case where the length of the second element 12 is set at about ¼ of the wavelength λ.

For example, in the glass antenna according to the background art, when the length of the coaxial cable between the earth-side feeding point (or the DAB amplifier) and the midpoint earth is increased, the impedance of the glass antenna becomes higher, and the antenna gain becomes lower.

On the other hand, in the glass antenna 1 according to the embodiment, the length of the second element 12 is set between the length obtained by multiplying ½ of the wavelength λ by the wavelength shortening rate of the rear glass 100 and the length obtained by multiplying the wavelength λ by the wavelength shortening rate, so that the impedance of the glass antenna 1 can be lowered. That is, in the glass antenna 1 according to the embodiment, for example, even when the length of the coaxial cable 30 between the earth-side feeding point 14 (or the DAB amplifier 15) and the midpoint earth 31 is increased, the impedance of the glass antenna 1 can be lowered because the length of the second element 12 is made longer than that in the glass antenna according to the background art. Accordingly, in the glass antenna 1 according to the embodiment, for example, even when the midpoint earth 31 is placed at a farther point due to use of the resin backdoor 2, the receiving sensitivity can be improved as shown in FIG. 3.

In addition, according to the embodiment, the outer conductor of the coaxial cable 30 is connected to a part of the vehicle body 3 in the position (midpoint earth 31) corresponding to a length of at least ¼ of the wavelength λ from the earth-side feeding point 14. In addition, according to the embodiment, the rear glass 100 for the vehicle is attached to the resin backdoor 2 which is openably and closably attached to the rear portion of the vehicle.

Generally, when the backdoor 2 is made from resin, the midpoint earth 31 cannot be provided in the backdoor 2. Thus, the coaxial cable 30 is located in a position corresponding to a length of at least ¼ of the wavelength λ from the earth-side feeding point 14. Even in such a case, the length of the second element 12 is increased so that the receiving sensitivity can be improved in the glass antenna 1 according to the embodiment.

In addition, according to the embodiment, the first element 11 and the second element 12 are disposed at a distance with which the first element 11 and the second element 12 can be capacitively coupled with each other in the DAB frequency band (frequency band to be received).

Accordingly, due to the capacitive coupling between the first element 11 and the second element 12, the impedance is further lowered so that the receiving sensitively can be improved in the glass antenna 1 according to the embodiment.

In addition, according to the embodiment, the first element 11 is disposed (for example, at a distance of 10 mm from the defogger 20) to be capacitively coupled with the defogger 20 in the DAB frequency band (frequency band to be received). In addition, the second element 12 is disposed (for example, at a distance of 10 mm from the T-shaped element 22 (third element) connected to the defogger 20) to be capacitively coupled with the T-shaped element 22 in the DAB frequency band (frequency band to be received).

Accordingly, the impedance is further lowered so that the receiving sensitively can be improved in the glass antenna 1 according to the embodiment.

In addition, according to the embodiment, the wavelength λ is a wavelength corresponding to the central frequency of the DAB frequency band (frequency band to be received).

Accordingly, the length of the element 12 is determined based on the central frequency of the DAB frequency band (frequency band to be received). Thus, the glass antenna 1 according to the embodiment can obtain stable receiving sensitivity all over the DAB frequency band (frequency band to be received).

In addition, according to the embodiment, the first element 11 is disposed outside the defogger 20 disposed at the center of the rear glass 100, and the second element 12 is disposed further outside the first element 11. That is, the first element 11 is disposed between the second element 12 and the defogger 20.

Accordingly, in the glass antenna 1 according to the embodiment, it is possible to easily establish capacitive coupling between the first element 11 and the defogger 20 and between the first element 11 and the second element 12.

### Second Embodiment

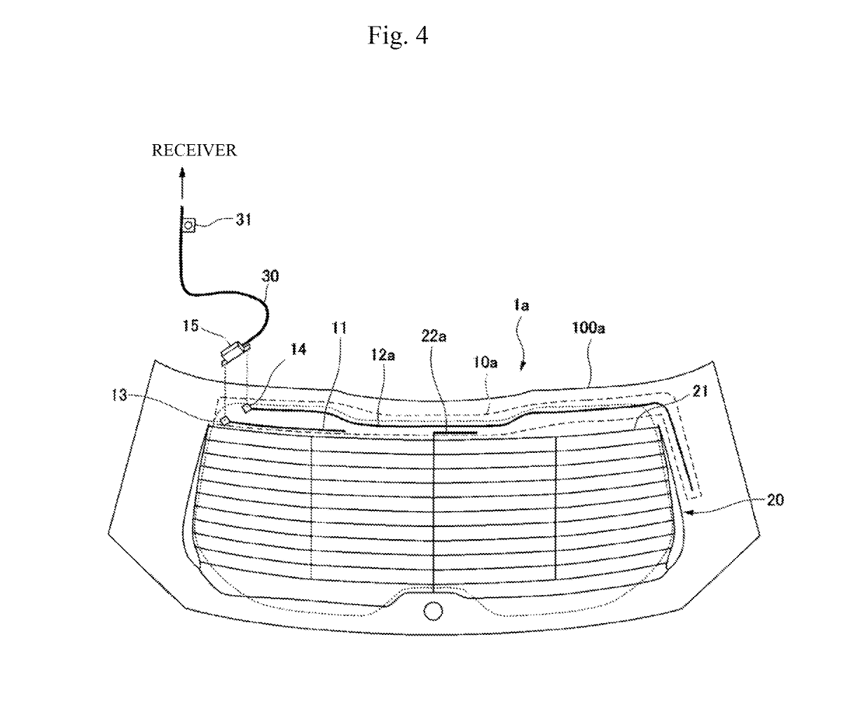

Next, a glass antenna 1a according to a second embodiment will be described with reference to FIG. 4.

FIG. 4 is a view showing a configuration example of the glass antenna 1a according to the second embodiment. In FIG. 4, constituents the same as those in FIG. 2 are referenced correspondingly, and their description will be omitted.

In addition, a configuration in which the glass antenna 1a is mounted on a vehicle is fundamentally the same as that in the first embodiment shown in FIG. 1. Therefore, description of the configuration will be omitted. In the embodiment, the backdoor 2 is made from resin in the same manner as in the first embodiment.

The glass antenna 1a according to the embodiment is different from the first embodiment in that the second element 12a is expanded to a right region (a blank region on the right side) of the defogger 20, and in that an L-shaped element 22a is provided in place of the T-shaped element 22.

As shown in FIG. 4, the glass antenna 1a includes a rear glass 100a, the DAB amplifier 15, and the coaxial cable 30. In addition, a defogger 20, a DAB antenna portion 10a and the L-shaped element 22a are disposed in the rear glass 100a.

The DAB antenna portion 10a is a bipolar type antenna for receiving radio waves in the DAB frequency band. The DAB antenna portion 10a is disposed in the peripheral region of the defogger 20 (for example, blank regions on the upper and right sides of the defogger 20) of the rear glass 100a. The DAB antenna portion 10a includes the first element 11, the second element 12a, the hot-side feeding point 13, and the earth-side feeding point 14.

The second element 12a is a conductor such as metal disposed in the rear glass 100a. The second element 12a is disposed in the peripheral region of the defogger 20 so as to extend in opposition to and in parallel with at least a part of the first element 11, and connected to the earth-side feeding point 14. The second element 12a is, for example, disposed in, of the rear glass 100a, the blank regions on the upper and right sides of the defogger 20 and outside the first element 11. That is, the second element 12a is disposed to extend in the rear glass 100a from the blank region (upper region) on the upper side of the defogger 20 to the right region (side region) of the defogger 20 and along the periphery of the defogger 20. In addition, the second element 12a is disposed at a predetermined distance (for example, a distance of 10 mm) from the L-shaped element 22a connected to the defogger 20 so as to be capacitively coupled with the L-shaped element 22a in the DAB frequency band.

In addition, the length of the second element 12a is similar to that of the second element 12 in the first embodiment. Therefore, description thereof will be omitted.

In addition, the first element 11 and the second element 12a are disposed substantially in parallel with each other and at a distance from each other in the upper region of the defogger 20 so that the first element 11 and the second element 12a can be capacitively coupled with each other in the DAB frequency band. In addition, the first element 11 and the second element 12a are disposed with the second element 12a on the peripheral side (flange side) and the first element 11 on the defogger 20 side.

The L-shaped element 22a (an example of a third element) is an L-shaped conductor such as metal disposed in the rear glass 100a, and connected to the heating wires 21 of the defogger 20. The L-shaped element 22a is, for example, connected to the centers of the heating wires 21 of the defogger 20.

As described above, the glass antenna 1a according to the embodiment includes the first element 11, the second element 12a, and the coaxial cable 30. The first element 11 is disposed in, of the rear glass 100a (rear glass) for the vehicle, the peripheral region (for example, the upper region) of the defogger 20 including the plurality of heating wires 21, and connected to the hot-side feeding point 13 (first feeding point). The second element 12a is disposed in the peripheral region (for example, the upper region and the side region) of the defogger 20 so as to be in opposition to and in parallel with at least a part of the first element 11, and connected to the earth-side feeding point 14 (second feeding point). In addition, the second element 12a has a length between a length obtained by multiplying ½ of the wavelength λ corresponding to the DAB frequency band (frequency band to be received) by the wavelength shortening rate (k=0.64) of the rear glass 100a and a length obtained by multiplying the wavelength λ by the wavelength shortening rate (k=0.64).

As a result, the glass antenna 1a according to the embodiment can improve the receiving sensitivity (antenna gain) in the same manner as in the first embodiment. In addition, the glass antenna 1a according to the embodiment can reduce (be hard to receive) influence of noise.

In addition, in the glass antenna 1a according to the embodiment, the second element 12a is disposed using the side region as well as the upper region. Accordingly, the rear glass 100a can be used efficiently. The glass antenna 1a according to the embodiment can be applied to a vehicle (car) such as a compact car in which the backdoor 2 is made from resin, and the rear glass 100a has a small area.

In addition, according to the embodiment, the second element 12a is disposed (for example, at a distance of 10 mm from the L-shaped element 22a (third element) connected to the defogger 20) to be capacitively coupled with the L-shaped element 22a in the DAB frequency band (frequency band to be received).

Accordingly, the impedance is further lowered so that the receiving sensitively can be improved in the glass antenna 1a according to the embodiment, in the same manner as in the first embodiment where the T-shaped element 22 is provided.

### Third Embodiment

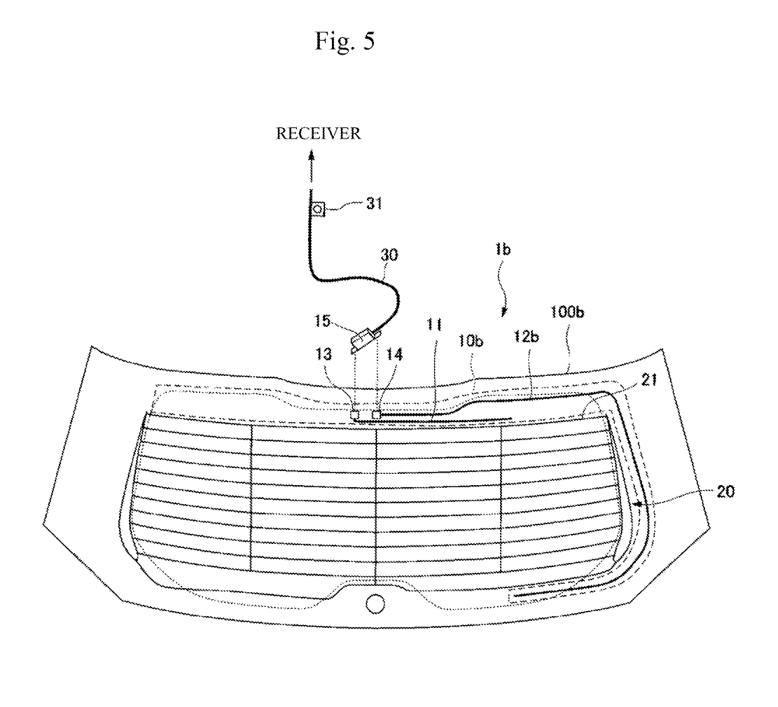

Next, a glass antenna 1b according to a third embodiment will be described with reference to FIG. 5.

FIG. 5 is a view showing a configuration example of the glass antenna 1b according to the third embodiment. In FIG. 5, constituents the same as those in FIG. 2 are referenced correspondingly, and their description will be omitted.

In addition, a configuration in which the glass antenna 1b is mounted on a vehicle is fundamentally the same as that in the first embodiment shown in FIG. 1. Therefore, description of the configuration will be omitted. In the embodiment, the backdoor 2 is made from resin in the same manner as in the first embodiment.

The glass antenna 1b according to the embodiment is different from the first embodiment in that the hot-side feeding point 13 and the earth-side feeding point 14 are disposed in a central portion of an upper region of a rear glass 100b, and in that the second element 12b is extended to a lower region of the defogger 20. In addition, the glass antenna 1b according to the embodiment is different from the first embodiment in that the T-shaped element 22 is not provided.

As shown in FIG. 5, the glass antenna 1b includes the rear glass 100b, the DAB amplifier 15, and the coaxial cable 30. In addition, the defogger 20 and a DAB antenna portion 10b are disposed in the rear glass 100b.

The DAB antenna portion 10b is a bipolar type antenna for receiving radio waves in the DAB frequency band. The DAB antenna portion 10b is disposed in, of the rear glass 100b, the peripheral region of the defogger 20 (for example, blank regions on the upper, right and lower sides of the defogger 20). The DAB antenna portion 10b includes the first element 11, a second element 12b, the hot-side feeding point 13, and the earth-side feeding point 14.

The hot-side feeding point 13 and the earth-side feeding point 14 in the embodiment are the same as those in the first embodiment, except that the hot-side feeding point 13 and the earth-side feeding point 14 are disposed in the blank region (a central portion of the upper region) on the upper side of the defogger 20. In addition, the first element 11 in the embodiment is the same as that in the first embodiment, except that the first element 11 is disposed in the blank region (upper region) on the upper side of the defogger 20 so as to extend from the central portion toward the left portion.

The second element 12b is a conductor such as metal disposed in the rear glass 100b. The second element 12b is disposed in the peripheral region of the defogger 20 so as to extend in opposition to and in parallel with at least a part of the first element 11, and connected to the earth-side feeding point 14. The second element 12b is, for example, disposed in, of the rear glass 100b, the blank regions on the upper, right and lower sides of the defogger 20 and outside the first element 11. That is, the second element 12b is disposed in the rear glass 100b so as to extend from the upper region of the defogger 20 through the right region (side region) to the blank region (lower region) on the lower side, and along the periphery of the defogger 20.

In addition, the length of the second element 12b is similar to that of the second element 12 in the first embodiment. Therefore, description thereof will be omitted.

In addition, the first element 11 and the second element 12b are disposed substantially in parallel with each other and at a distance from each other in the upper region of the defogger 20 so that the first element 11 and the second element 12b can be capacitively coupled with each other in the DAB frequency band. In addition, the first element 11 and the second element 12b are disposed with the second element 12b on the peripheral side (flange side) and the first element 11 on the defogger 20 side.

As described above, the glass antenna 1b according to the embodiment includes the first element 11, the second element 12b, and the coaxial cable 30. The first element 11 is disposed in, of the rear glass 100b (rear glass) for the vehicle, the peripheral region (for example, the upper region) of the defogger 20 including the plurality of heating wires 21, and connected to the hot-side feeding point 13 (first feeding point). The second element 12b is disposed in the peripheral region (for example, the upper region, the side region and the lower region) of the defogger 20 so as to be in opposition to and in parallel with at least a part of the first element 11, and connected to the earth-side feeding point 14 (second feeding point). In addition, the second element 12b has a length between a length obtained by multiplying ½ of the wavelength λ corresponding to the DAB frequency band (frequency band to be received) by the wavelength shortening rate (k=0.64) of the rear glass 100b and a length obtained by multiplying the wavelength λ by the wavelength shortening rate (k=0.64).

As a result, the glass antenna 1b according to the embodiment can improve the receiving sensitivity (antenna gain) in the same manner as in the first and second embodiments. In addition, the glass antenna 1b according to the embodiment can reduce (be hard to receive) influence of noise.

In addition, in the glass antenna 1b according to the embodiment, the second element 12b is disposed using the side region and the lower region as well as the upper region. Accordingly, the rear glass 100b can be used efficiently. The glass antenna 1b according to the embodiment can be applied to a vehicle (car) such as a compact car in which the backdoor 2 is made from resin, and the rear glass 100a has a small area.

The invention is not limited to any of the aforementioned embodiments, and changes can be made on the invention without departing from its gist.

For example, an example in which the frequency band to be received in the glass antenna 1 (1a, 1b) is a DAB frequency band has been described in each embodiment, but the frequency band to be received may be another frequency band. The frequency band to be received may be, for example, a frequency band of FM radio, a frequency band of terrestrial digital TV, or the like.

In addition, an example in which the wavelength λ corresponding to the DAB frequency band is a wavelength corresponding to the central frequency of the DAB frequency band has been described in each embodiment. However, the wavelength λ may be a wavelength corresponding to another frequency of the wavelength λ is determined based on the DAB frequency band. For example, the wavelength λ may be in a range from a wavelength obtained by multiplying a wavelength corresponding to the highest frequency in the DAB frequency band by a predetermined coefficient (for example, (1−Q)) to a wavelength obtained by multiplying a wavelength λ_{FMmax} corresponding to the lowest frequency in the DAB frequency band by a predetermined coefficient (for example, (1+Q)). For example, the variable Q may be 0.10 designating ±10%, or may be another value.

In addition, an example in which the first element 11 has a length of about ¼λ capable of resonating with the frequency band to be received has been described in each embodiment. However, the first element 11 may have another length such as about ¾λ capable of resonating likewise.

In addition, an example in which the wavelength shortening rate k is 0.64 has been described in each embodiment. However, the wavelength shortening rate k may be another value corresponding to the composition of the rear glass 100 (100a, 100b).

In addition, an example in which the glass antenna 1 (1a, 1b) includes the DAB amplifier 15 has been described in each embodiment. However, the DAB amplifier 15 does not have to be included in the configuration. In addition, the DAB antenna portion 10 (10a, 10b) may have a configuration including the DAB amplifier 15, or a configuration not including the DAB amplifier 15.

In addition, an example in which the backdoor 2 is a vertically openable/closable door has been described in each embodiment. However, the backdoor 2 may be a laterally openable/closable door.

In addition, an example in which the backdoor 2 is made from resin has been described in each embodiment. However, the backdoor 2 may be made of metal.

In addition, an example in which the glass antenna 1b does not have the third element (such as the T-shaped element 22 or the L-shaped element 22a) has been described in the third embodiment. However, the third element may be included in the configuration. In addition, the third element does not have to be included in the configuration in the first or second embodiment.

The present application is based on Japanese Patent Application No. 2016-174035 filed Sep. 6, 2016, the contents of which are incorporated herein by reference.

### DESCRIPTION OF REFERENCE NUMERALS AND SIGNS

1,1a,1b glass antenna
2 backdoor
3 vehicle body
10,10a,10b DAB antenna portion
11 first element
12,12a,12b second element
13 hot-side feeding point
14 earth-side feeding point
15 DAB amplifier
20 defogger
21 heating wire
22 T-shaped element
22a L-shaped element
30 coaxial cable
31 midpoint earth
40 grommet
100,100a,100b rear glass

What is claimed is:

1. A glass antenna comprising:
a first element that is disposed in, of a rear glass for a vehicle, a peripheral region of a defogger including a plurality of heating wires, and connected to a first feeding point, the first element capable of resonating with a frequency band to be received;
a second element that is disposed in opposition to and in parallel with at least a part of the first element, and connected to a second feeding point, the second element having a length between a length obtained by multiplying ½ of a wavelength corresponding to the frequency band to be received by a wavelength shortening rate of the rear glass and a length obtained by multiplying the wavelength by the wavelength shortening rate; and
a coaxial cable that includes an inner conductor connected to the first feeding point and an outer conductor connected to the second feeding point, the outer conductor being connected to a part of a body of the vehicle.

2. The glass antenna according to claim 1, wherein:
the outer conductor of the coaxial cable is connected to a part of the body of the vehicle in a position corresponding to a length of at least ¼ of the wavelength from the second feeding point.

3. The glass antenna according to claim 1, wherein:
the first element and the second element are disposed at a distance from each other so that the first element and the second element are capacitively coupled with each other in the frequency band to be received.

4. The glass antenna according to claim 1, wherein:
the first element is disposed to be capacitively coupled with the defogger in the frequency band to be received; and
the second element is disposed to be capacitively coupled with a third element in the frequency band to be received, the third element being connected to the defogger.

5. The glass antenna according to claim 1, wherein:
the first element is disposed between the second element and the defogger.

6. The glass antenna according to claim 1, wherein:
the wavelength is a wavelength corresponding to a central frequency of the frequency band to be received.

7. The glass antenna according to claim 1, wherein:
the rear glass for the vehicle is attached to a backdoor made from resin, the backdoor being openably and closably attached to a rear portion of the vehicle.
